(19) United States
(12) Patent Application Publication
(10) Pub. No.: US 2023/0328806 A1
(43) Pub. Date: Oct. 12, 2023

(54) RELAY DEVICE, TERMINAL, AND RELAY METHOD

(71) Applicant: NEC Corporation, Minato-ku, Tokyo (JP)

(72) Inventor: Takuya SHOJI, Tokyo (JP)

(73) Assignee: NEC Corporation, Minato-ku, Tokyo (JP)

(21) Appl. No.: 18/023,115

(22) PCT Filed: Aug. 30, 2021
(86) PCT No.: PCT/JP2021/031696

§ 371 Date: Feb. 24, 2023

(30) Foreign Application Priority Data
Aug. 31, 2020 (JP) 2020-145194

(51) Int. Cl. H04W 76/10; H04W 12/06; H04W 12/037

(52) U.S. Cl. CPC H04W 76/10; H04W 12/037; H04W 12/06

(57) ABSTRACT

In order to suppress a terminal from being connected to an inappropriate system when failures occur in a base station, this relay device comprises: a transmission means that, when failures occur in a base station, transmits a connection request including authentication information to a terminal connected to a network via the base station; a reception means that receives, from the terminal that has received the connection request, a notification indicating that connection is permitted; and a relay means that, upon being notified by the reception means that the notification has been received, relays communication between the terminal and the network.

### TECHNICAL FIELD

The present invention relates to a relay device, a terminal, and a relay method that enable connection with a relay device in place of a base station.

### BACKGROUND ART

When a disaster such as an earthquake occurs, the Meteorological Agency or the like transmits a disaster prompt report containing information relating to an earthquake (for example, a magnitude, a seismic center, and the like) to a terminal owned by an individual, via a network. In this case, the terminal communicates with the network via a base station associated with authentication information registered in advance. However, when collapse of a base station or the like occurs due to a disaster such as an earthquake, a disaster prompt report is not transmitted to a terminal.

Further, PTL 1 discloses that, when a communication failure is detected, a base station determines that the communication failure is caused by a disaster, and shifts to a disaster occurrence mode.

### CITATION LIST

### Patent Literature

[PTL 1] Japanese Unexamined Patent Application Publication No. 2012-156725

### SUMMARY OF INVENTION

### Technical Problem

However, PTL 1 does not describe processing to be executed when a failure occurs in the base station. Further, when a failure occurs in the base station, it may be possible to relay communication between a terminal and a network through use of a newly provided base station. However, in this case, in order to start communication with the newly provided base station, the terminal is required to establish a communication with a base station that is not associated with authentication information. At this time, there may be a risk that the terminal is connected to, for example, an inappropriate system that extracts information from the terminal, and performs introduction to a malicious web site, distribution of false information, or the like.

The present invention has been made in view of the above-mentioned problem, and an object of the present invention is to prevent a terminal from being connected to an inappropriate system when a failure occurs in a base station.

### Solution to Problem

A relay system according to the present invention includes:
a transmission means for transmitting a connection request containing authentication information to a terminal when a failure occurs in a base station, the terminal being connected to a network via the base station;
a reception means for receiving a notification indicating permission of connection from the terminal receiving the connection request; and
a relay means for relaying communication between the terminal and the network when the reception means notifies that the notification is received.

Further, a terminal according to the present invention includes:
a connection means for establishing a connection with a base station; and
a communication means for determining whether a connection request received from a relay device contains authentication information and transmitting, to the relay device, a notification indicating permission of connection when the connection request contains the authentication information, wherein
the connection means establishes a connection with the relay device in place of the base station, after the communication means transmits the notification to the relay device.

Further, a relay method according to the present invention includes:
transmitting a connection request containing authentication information to a terminal when a failure occurs in a base station, the terminal being connected to a network via the base station;
receiving a notification indicating permission of connection from the terminal receiving the connection request; and
relaying communication between the terminal and the network when the notification is received.

### Advantageous Effects of Invention

According to the present invention, the terminal is able to be prevented from being connected to an inappropriate system when a failure occurs in a base station.

### BRIEF DESCRIPTION OF DRAWINGS

FIG. 1 is a block diagram illustrating a configuration example of a relay system according to a first example embodiment of the present invention.

FIG. 2 is a diagram for describing the relay system according to the first example embodiment of the present invention.

FIG. 3 is a diagram for describing the relay system according to the first example embodiment of the present invention.

FIG. 4 is a diagram for describing the relay system according to the first example embodiment of the present invention.

FIG. 5 is a flowchart illustrating an operation example of the relay system according to the first example embodiment of the present invention.

FIG. 6 is a block diagram illustrating a configuration of a first modification example of the relay system according to the first example embodiment of the present invention.

FIG. 7 is a diagram for describing the first modification example of the relay system according to the first example embodiment of the present invention.

FIG. 8 is a flowchart illustrating an operation in the first modification example of the relay system according to the first example embodiment of the present invention.

FIG. 9 is a block diagram illustrating a configuration of a second modification example of the relay system according to the first example embodiment of the present invention.

FIG. 10 is a diagram for describing the second modification example of the relay system according to the first example embodiment of the present invention.

FIG. 11 is a flowchart illustrating an operation in the second modification example of the relay system according to the first example embodiment of the present invention.

FIG. 12 is a block diagram illustrating a configuration example of a relay device according to a second example embodiment of the present invention.

FIG. 13 is a flowchart illustrating an operation example of the relay device according to the second example embodiment of the present invention.

FIG. 14 is a block diagram illustrating a configuration example of a terminal according to a third example embodiment of the present invention.

FIG. 15 is a flowchart illustrating an operation example of the terminal according to the third example embodiment of the present invention.

### EXAMPLE EMBODIMENT

### First Example Embodiment

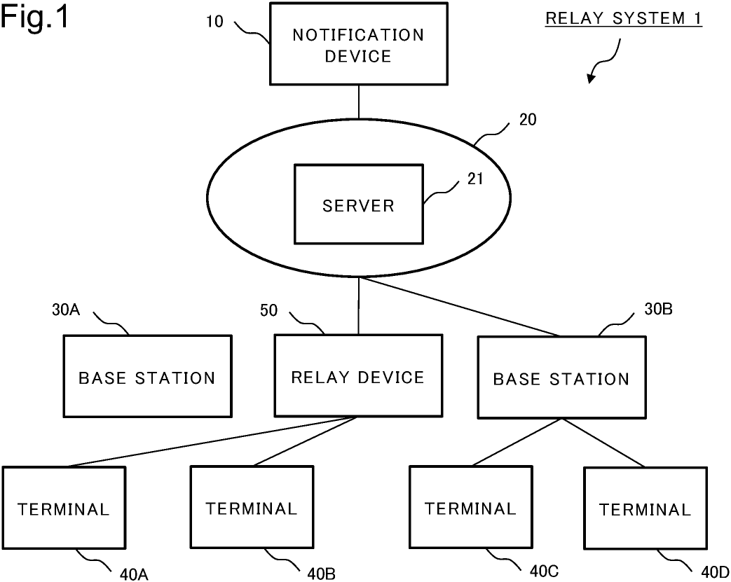

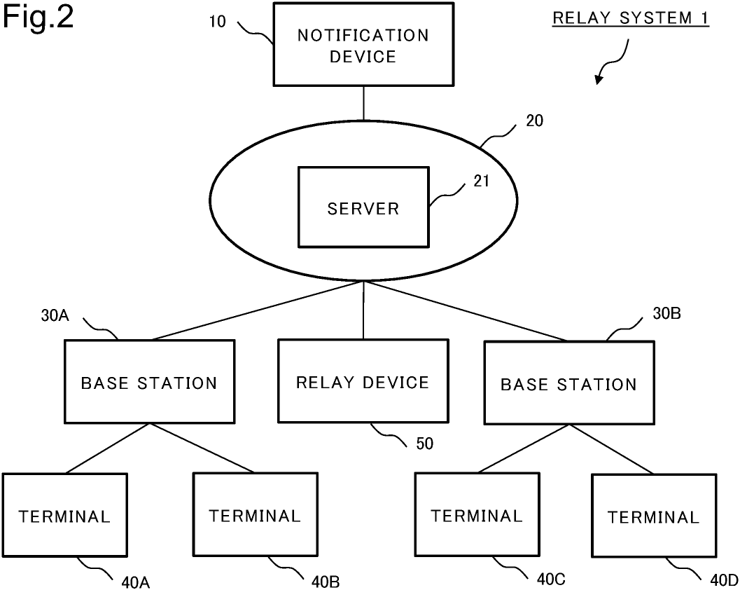

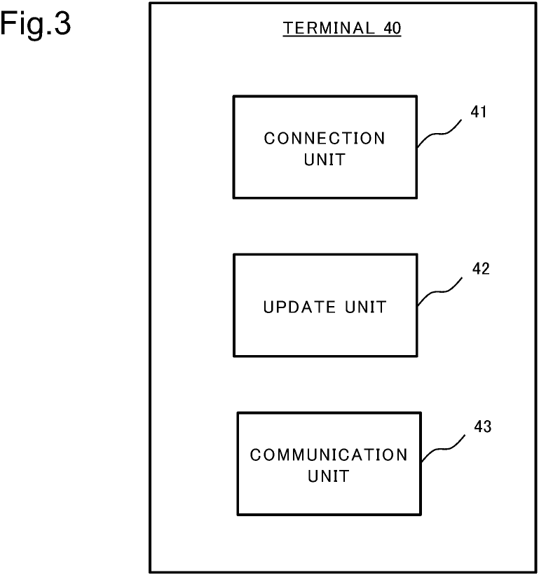

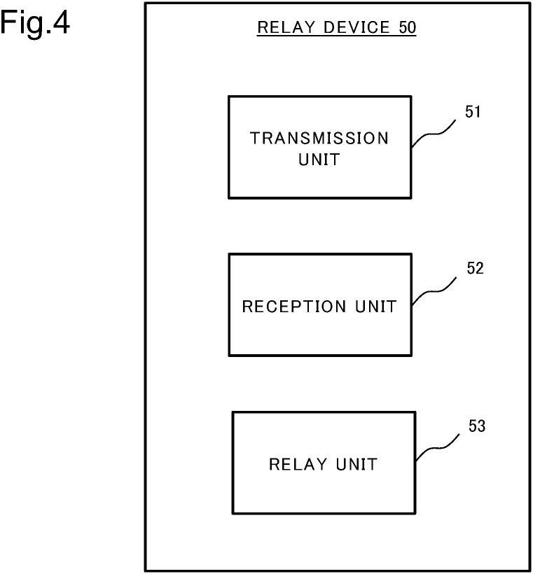

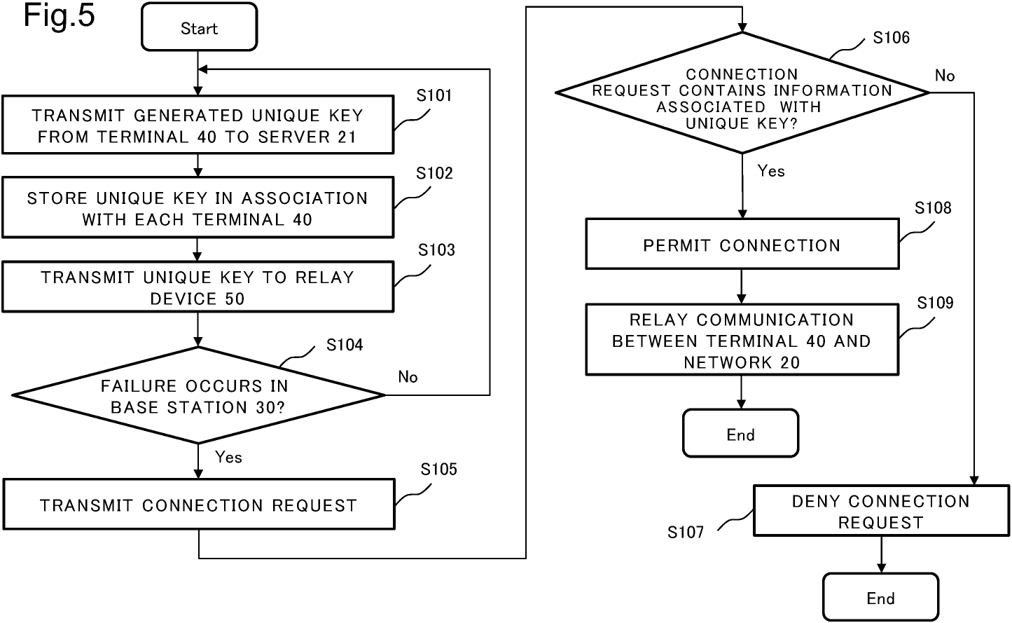

With reference to FIGS. 1, 2, 3, 4, and 5, a relay system 1 according to a first example embodiment is described. FIG. 1 is a block diagram illustrating a configuration example of the relay system 1. FIG. 2 is a block diagram for describing details of the relay system 1. FIG. 3 is a block diagram illustrating a configuration of a terminal 40 described later. FIG. 4 is a block diagram illustrating a configuration of a relay device 50 described later. FIG. 5 is a flowchart illustrating an operation example of the relay system 1.

The configuration of the relay system 1 is described. As illustrated in FIG. 1, the relay system 1 includes a notification device 10, a network 20, base stations 30A and 30B, terminals 40A, 40B, 40C, and 40D, and a relay device 50. In the description given below, when there is no need to distinguish the base stations 30A and 30B from each other, each of the base stations 30A and 30B is referred to as a base station 30. Further, when there is no need to distinguish the terminals 40A, 40B, 40C, and 40D from one another, each of the terminals 40A, 40B, 40C, and 40D is referred to as a terminal 40.

Further, FIG. 1 is a block diagram illustrating a configuration example of the relay system 1 after a failure occurs in the base station 30A due to a disaster or the like. Further, FIG. 2 is a block diagram illustrating a configuration example of the relay system 1 before a failure occurs in the base station 30A.

The notification device 10 is capable of communicating with the terminal 40 via the network 20, the base station 30, and the relay device 50. For example, when a disaster occurs, the notification device 10 transmits information relating to the disaster to the terminal 40. Here, the information relating to the disaster is an occurrence region, a damage situation, and the like of the disaster.

As illustrated in FIGS. 1 and 2, the notification device 10 communicates with the terminals 40A and 40B via the base station 30A before a failure occurs in the base station 30A. Further, the notification device 10 communicates with the terminals 40A and 40B via the relay device 50 after a failure occurs in the base station 30A.

The network 20 relays communication between any one of the base station 30 and the relay device 50, and the notification device 10. The network 20 includes at least a server 21. For example, the server 21 is a Home Subscriber Server (HSS). The server 21 communicates with the terminal 40, and shares a unique key with the terminal 40. The unique key is generated from an International Mobile Subscriber Identity (IMSI) recorded in a Subscriber Identity Module (SIM) card of the terminal 40 or an International Mobile Equipment Identifier (IMEI) of the terminal 40. The unique key is unique to the terminal 40. For example, a unique key of the terminal 40A and a unique key of the terminal 40B are different from each other. The unique key owned by the terminal 40A is associated with authentication information.

The base station 30 is a general base station. The base station 30A relays communication between the terminal 40A and the terminal 40B, and the notification device 10 via the network 20. The base station 30B relays communication between the terminal 40C and the terminal 40D, and the notification device 10 via the network 20.

The terminal 40 communicates with the notification device 10 via one of the base station 30 and the relay device 50, and the network 20. The terminal 40 shares the unique key with the server 21. As illustrated in FIG. 3, the terminal 40 includes a connection unit 41, an update unit 42, and a communication unit 43. The connection unit 41 performs path control in such a manner that the terminal 40 is connected to the network 20 via the base station 30. The update unit 42 of the terminal 40 updates the unique key as required. For example, the terminal 40 updates the unique key at the time of activation of the terminal 40 or in a cycle that is set in advance. The communication unit 43 of the terminal 40 transmits the updated unique key to the server 21. At this point, the communication unit 43 transmits the unique key to the server 21 of the network 20 via the base station 30 through the path set by the connection unit 41. The server 21 transfers, to the relay device 50, the unique key transmitted from the communication unit 43. In other words, the communication unit 43 transmits the unique key to the relay device 50.

As illustrated in FIG. 2, the connection units 41 of the terminals 40A and 40B connect the network 20, and the terminals 40A and 40B to each other via the base station 30A until a failure occurs in the base station 30A. As illustrated in FIG. 1, the connection units 41 of the terminals 40A and 40B connect the network 20, and the terminals 40A and 40B to each other via the relay device 50 after a failure occurs in the base station 30A. Further, the connection units 41 of the terminals 40C and 40D connect the network 20, and the terminals 40C and 40D via the base station 30B.

The relay device 50 is provided in such a manner as to be communicable with the server 21 at all times. As illustrated in FIG. 4, the relay device 50 includes a transmission unit 51, a reception unit 52, and a relay unit 53. The relay device 50 communicates with the server 21, and thus acquires the unique key of each of the terminals 40. As illustrated in FIG. 2, the relay device 50 is not connected to the terminal 40 until a failure occurs in the base station 30. At this point, it is assumed that the relay device 50 communicates with the server 21, and thus acquires the unique key. Further, when the relay device 50 does not communicate with the server 21, a manager of the relay system 1 may input the unique key to the relay device 50.

When it is determined that a failure occurs in the base station 30A, the transmission unit 51 transmits, to the terminal 40, a connection request containing the unique key. For example, when the transmission unit 51 is notified of occurrence of a failure in the base station 30A from the outside, it is determined that a failure has occurred in the base station 30A. When the unique key contained in the connection request matches with the unique key of its own, the terminal 40 that receives the connection request transmits a notification indicating connection permission to the relay device 50.

The reception unit 52 receives the notification indicating connection permission from the terminal 40 that receives the connection request. When the reception unit 52 receives the notification, the relay unit 53 is connected to the terminal 40 that transmits the notification, and relays communication between the terminal 40 and the network.

The configuration of the relay system 1 is described above. Next, with reference to FIG. 5, an operation example of the relay system 1 is described. It is assumed that, at the time of starting this operation example, the connection unit 41 performs path control of the terminal 40 in such a manner that the terminal 40 is connected to the network 20 via the base station 30.

The communication unit 43 of the terminal 40 transmits, to the server 21, the unique key generated by the update unit 42 (S101).

The server 21 store the unique keys that are received from the plurality of terminals 40, in association with the terminals 40 (S102).

The server 21 transmits the unique key of each of the terminals 40 to the relay device 50 in a predetermined cycle (S103). Thereby, the relay device 50 acquires the unique key of each of the terminals 40.

The relay device 50 determines whether a failure occurs in the base station 30 (S104). When a failure occurs in the base station 30, the operation of the base station 30 is stopped. For example, the network 20 determines that a failure has occurred in the base station 30 when there is no response from the base station 30. For example, the relay device 50 determines presence or absence of a failure in the base station 30, based on the notification from the network 20.

When a failure does not occur in the base station 30 (No in S104), the relay system 1 repeats the processing in S101 to S103.

When a failure occurs in the base station 30 (Yes in S104), the transmission unit 51 of the relay device 50 transmits a connection request containing the unique key of each of the terminals 40, to the terminals 40 located within a predetermined range (S105). At this point, it is assumed that the terminals 40A and 40B are located within the predetermined range. In a case in which a disaster occurs in a region in which the base station 30 is provided, when the relay device 50 is arranged in the vicinity of the base station 30, a failure may occur not only in the base station 30 but also in the relay device 50. Thus, the relay device 50 is stored at a location away from the base station 30 before a failure occurs in the base station 30. For example, when a failure occurs in the base station 30A, the relay device 50 is carried, for example, by a vehicle of a manager of the relay system 1 to the periphery of the base station 30A.

The terminal 40 determines whether the received connection request contains the unique key owned by the terminal 40 (S106). Thereby, the terminal 40 determines whether the relay device 50 owns the unique key generated by the terminal 40.

When the connection request does not contain the unique key owned by the terminal 40 (No in S106), the terminal 40 denies the connection request from the relay device 50 (S107). At this point, the operation of the relay system 1 is terminated.

When the connection request contains the unique key owned by the terminal 40 (Yes in S106), the terminal 40 permits the connection request from the relay device 50 (S108). At this point, the terminal 40 transmits the notification indicating connection permission to the reception unit 52 of the relay device 50.

When the reception unit 52 receives the notification indicating connection permission, the relay unit 53 relays communication between the terminal 40 and the network 20 (S109). Thereby, for example, the terminals 40A and 40B are connected to the network 20 via the relay device 50 in place of the base station 30A, and thus acquire information relating to a disaster from the notification device 10. The reception unit 52 that receives the notification indicating connection permission notifies the relay unit 53 that the notification is received. When the notification is detected, the relay unit 53 determines that the reception unit 52 has received the notification indicating connection permission. The operation of the relay system 1 is described above.

As described above, the relay device 50 in the relay system 1 includes the transmission unit 51, the reception unit 52, and the relay unit 53. When a failure occurs in the base station 30, the transmission unit 51 transmits a connection request containing authentication information (unique key) to the terminal 40 being connected to the network 20 via the base station 30. The reception unit 52 receives a notification indicating connection permission from the terminal 40 that receives the connection request. When the notification indicating connection permission is received, the relay unit 53 relays communication between the terminal 40 and the network 20.

Thereby, even when a failure occurs in the base station 30 due to a disaster or the like, the terminal 40 is capable of communicating with the network 20. At this point, the terminal 40 communicates with the network 20 via the relay device 50 that stores shared information (authentication information). Thus, the terminal 40 in the relay system 1 can be prevented from communicating with a device that does not have authentication information. As a result, the terminal 40 has a low risk of being connected to an inappropriate system that extracts information from the terminal, and performs introduction to a malicious web site, distribution of false information, or the like.

### [First Modification Example]

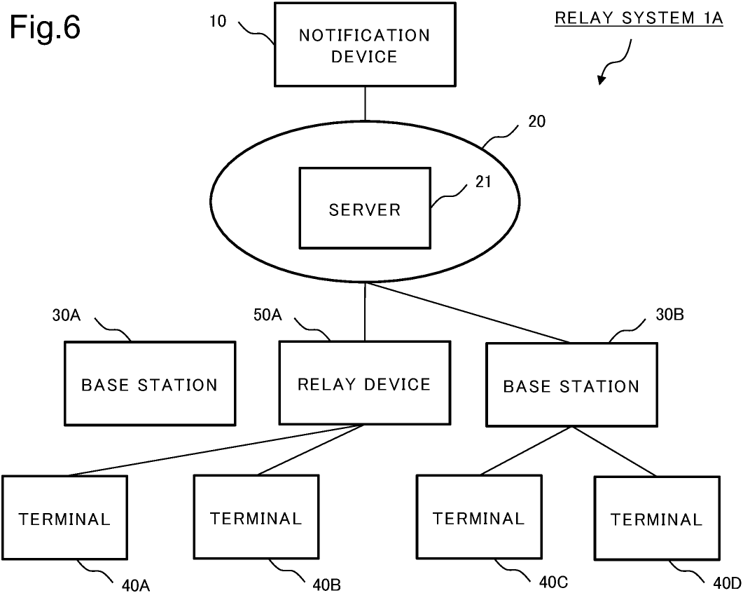

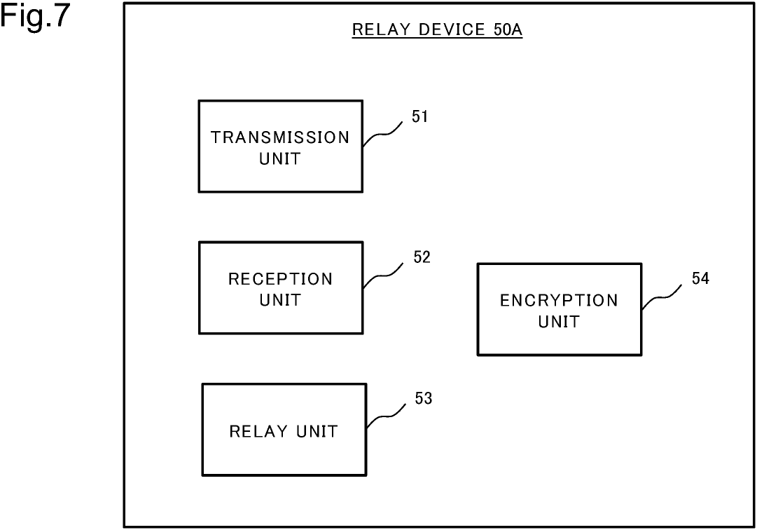

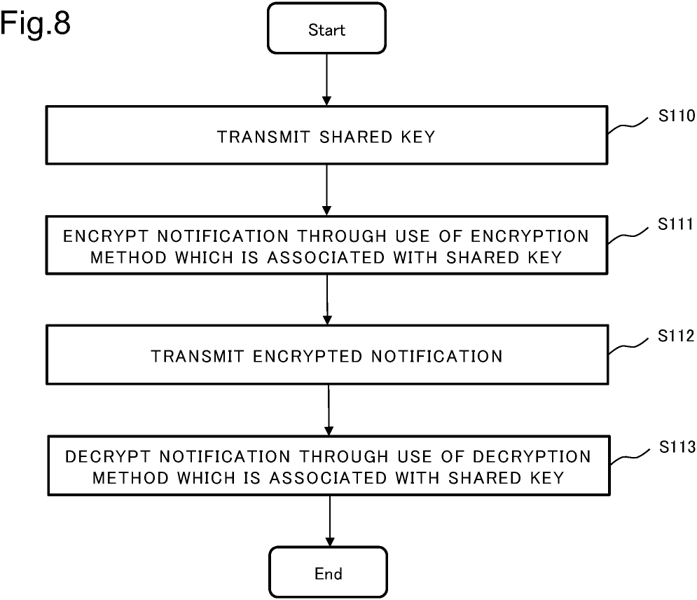

Next, with reference to FIGS. 6, 7, and 8, a relay system 1A according to a first modification example of the first example embodiment is described. FIG. 6 is a block diagram illustrating a configuration example of the relay system 1A. FIG. 7 is a block diagram illustrating a configuration of a relay device 50A described later. FIG. 8 is a flowchart illustrating an operation of the relay system 1A.

As illustrated in FIG. 6, the relay system 1A includes a configuration similar to that of the relay system 1 according to the first example embodiment. The relay system 1A is different from the relay system 1 in that the relay device 50A is included in place of the relay device 50.

With reference to FIG. 7, the relay device 50A is described. The relay device 50A includes the connection-related objects, the configurations, and the functions included in the relay device 50. Specifically, the relay device 50A includes the transmission unit 51, the reception unit 52, and the relay unit 53. The relay device 50A further includes an encryption unit 54 and a transmission unit 55. The transmission unit 55 transmits a shared key to the terminal 40 that permits the connection request. The shared key indicates a cryptosystem to be used for encryption and decryption of data. When a notification of information relating to a disaster is received from the notification device 10, the encryption unit 54 of the relay device 50A encrypts the received notification through use of the shared key. Then, the transmission unit 55 transmits the encrypted notification to the terminal 40. The terminal 40 that owns the shared key decrypts the encrypted notification through use of the shared key.

Next, with reference to FIG. 8, the operation of the relay system 1A is described. Similarly to the relay system 1 described above, the relay system 1A performs the operation illustrated in FIG. 5. It is assumed that the operation of the relay system 1A illustrated in FIG. 8 is performed after the processing in S109.

After relay of communication between the terminal 40 and the network 20 is started in the processing in S109, the transmission unit 51 of the relay device 50A further transmits the shared key to the terminal 40 that permits the connection request (S110).

The encryption unit 54 of the relay device 50 encrypts the notification received from the notification device 10, through use of an encryption method which is associated with the shared key (S111). The transmission unit 51 transmits the encrypted information to the terminal 40 that permits the connection request (S112).

The terminal 40 receives the encrypted information, and performs decryption through use of a decryption method which is associated with the shared key (S113). At this point, the terminal 40 displays the decrypted information on a display screen of the terminal 40 or the like for a user of the terminal 40.

The operation of the relay system 1A is described above.

As described above, the relay system 1A includes the configuration similar to that of the relay system 1. Thus, similarly to the terminal 40 in the relay system 1, the terminal 40 in the relay system 1A has a low risk of being connected to an inappropriate system that extracts information from the terminal, and performs introduction to a malicious web site, distribution of false information, or the like.

Further, in the relay system 1A, the encryption unit 54 encrypts information from the network 20. Further, the transmission unit 51 transmits the encrypted information to the terminal 40.

In this manner, in the relay system 1A, information received from the network is encrypted according to a common key. Thus, even when a third party intercepts information transmitted from the relay device 50 to the terminal 40, the intercepted information is encrypted, and hence the third party cannot grasp the contents of the information. Therefore, in the relay system 1A, confidentiality of information being transmitted from the relay device 50 to the terminal 40 is secured.

### [Second Modification Example]

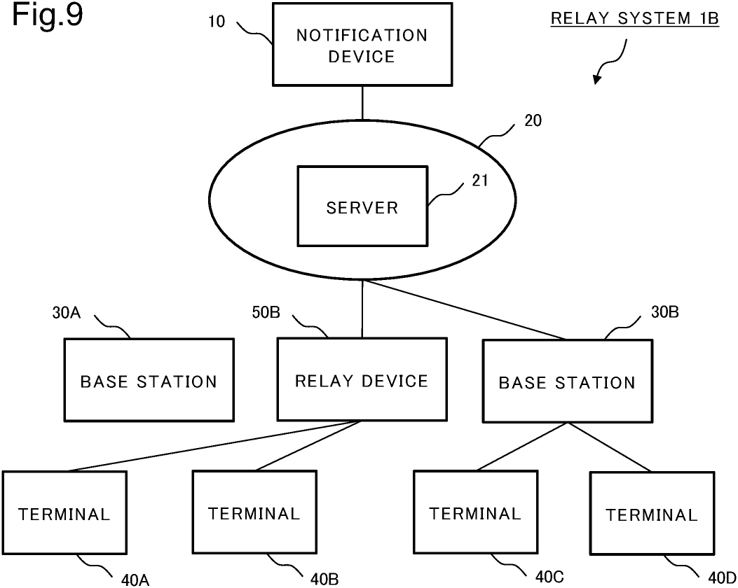

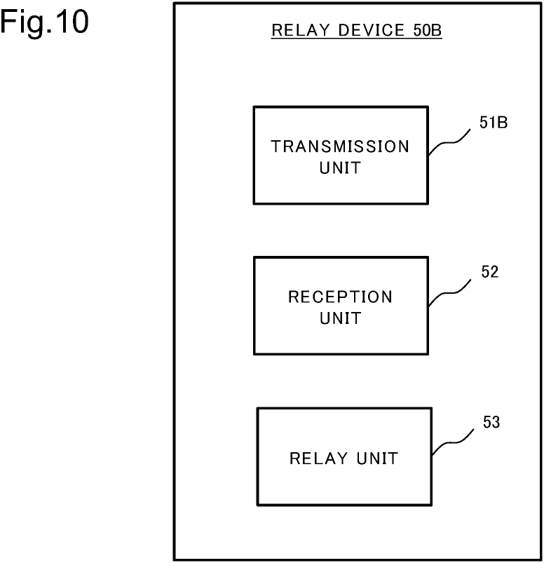

Next, with reference to FIGS. 9, 10, and 11, a relay system 1B according to a second modification example of the first example embodiment is described. FIG. 9 is a block diagram illustrating a configuration example the relay system 1B. FIG. 10 is a block diagram illustrating a configuration of a relay device 50B described later. FIG. 8 is a flowchart illustrating an operation of the relay system 1B.

As illustrated in FIG. 9, the relay system 1B includes a configuration similar to that of the relay system 1 according to the first example embodiment. The relay system 1B is different from the relay system 1 in that the relay device 50B is included in place of the relay device 50.

With reference to FIG. 10, the relay device 50B is described. The relay device 50B includes a transmission unit 51B, a reception unit 52, and a relay unit 53. The reception unit 52 and the relay unit 53 include configurations, connection-related objects, and functions similar to that of the reception unit 52 and the relay unit 53 in the relay device 50 described in the first example embodiment. Meanwhile, the transmission unit 51B is different from the transmission unit 51 in the relay device 50. Specifically, the transmission unit 51 determines whether a failure occurs in the base station 30A whereas the transmission unit 51B does not determine whether a failure occurs in the base station 30A. In response to an instruction from the outside, the transmission unit 51B transmits the connection request containing the unique key to the terminal 40.

For example, when a failure occurs in the base station 30A, a manager of the relay system 1B grasps occurrence of a failure in the base station 30A, based on information from the network 20. At this point, the manager transports the relay device 50B to the periphery of the base station 30A. The manager instructs the transported relay device 50B to transmit a connection request containing a unique key. As a result, the connection request is transmitted to the terminals 40A and 40B that are located in the periphery of the base station 30A. In this manner, in the relay system 1B, the relay device 50B transmits the connection request without determination on whether a failure occurs in the base station 30.

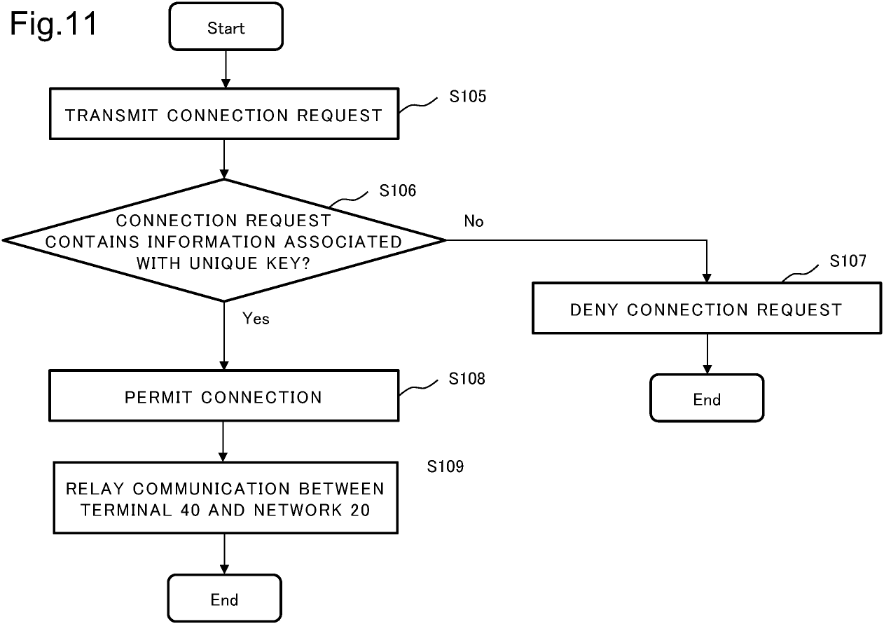

Next, with reference to FIG. 11, the operation of the relay system 1B is described. Before the operation is started, it is assumed that the relay device 50B stores the unique key of each of the terminals 40 that is input from a manager. Further, the operation is started in response to an instruction from the outside for transmitting the connection request.

As illustrated in FIG. 11, after the relay system 1B starts the operation, the processing similar to S105 to S109 in the relay system 1 is executed.

The relay system 1B is described above. As described above, the relay system 1B includes the configuration similar to that of the relay system 1. Thus, similarly to the terminal 40 in the relay system 1, the terminal 40 in the relay system 1B has a low risk of being connected to an inappropriate system that extracts information from the terminal, and performs introduction to a malicious web site, distribution of false information, or the like.

### Second Example Embodiment

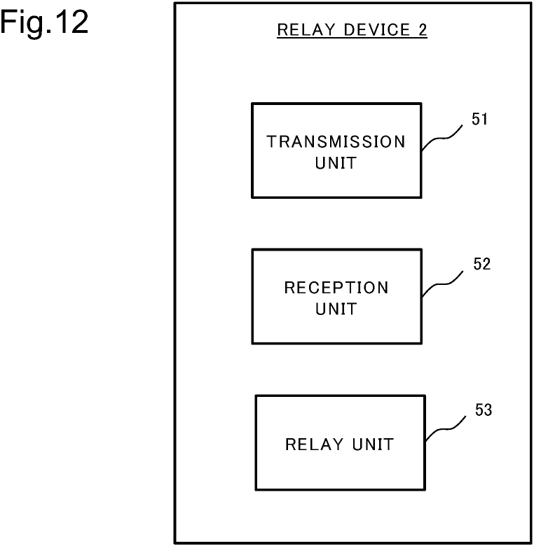

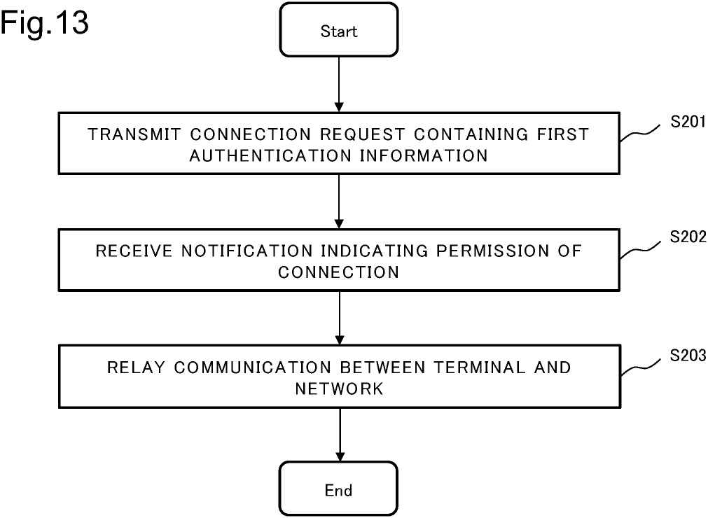

With reference to FIGS. 12 and 13, a relay device 2 according to a second example embodiment is described. FIG. 12 is a block diagram illustrating a configuration example of the relay device 2. FIG. 13 is a flowchart illustrating an operation example of the relay device 2.

As illustrated in FIG. 12, the relay device 2 incudes a transmission unit 51, a reception unit 52, and a relay unit 53.

When a failure occurs in a base station, the transmission unit 51 transmits a connection request containing authentication information to a terminal that is connected to a network via the base station. The transmission unit 51 may include a configuration, a function, and a connection-related object similar to that of the transmission unit 51 in the relay device 50 described in the first example embodiment.

The reception unit 52 receives a notification indicating connection permission from the terminal that receives the connection request. The reception unit 52 may include a configuration, a function, and a connection-related object similar to that of the reception unit 52 in the relay device 50 described in the first example embodiment.

When the reception unit 52 notifies that the notification indicating connection permission is received, the relay unit 53 relays communication between the terminal and the network. The relay unit 53 may include a configuration, a function, and a connection-related object similar to that of the relay unit 53 in the relay device 50 described in the first example embodiment.

Next, with reference to FIG. 13, an operation of the relay device 2 is described.

When a failure occurs in the base station, the transmission unit 51 transmits the connection request containing the authentication information to the terminal that is connected to the network via the base station (S201).

The reception unit 52 receives the notification indicating connection permission from the terminal that receives the connection request (S202).

When the notification indicating connection permission is received, the relay unit 53 relays communication between the terminal and the network (S203).

The operation of the relay device 2 is described above.

As described above, the relay device 2 includes the transmission unit 51, the reception unit 52, and the relay unit 53. When a failure occurs in the base station, the transmission unit 51 transmits the connection request containing the authentication information to the terminal that is connected to the network via the base station. The reception unit 52 receives the notification indicating connection permission from the terminal that receives the connection request. When the reception unit 52 notifies that the notification indicating connection permission is received, the relay unit 53 relays communication between the terminal and the network.

Thereby, even when a failure occurs in the base station due to a disaster or the like, the terminal is capable of communicating with the network. At this point, the terminal communicates with the network via the relay device 2 that has the authentication information.

Thus, the terminal can be prevented from communicating with a device that does not have authentication information. As a result, the terminal has a low risk of being connected to an inappropriate system that extracts information from the terminal, and performs introduction to a malicious web site, distribution of false information, or the like.

### Third Example Embodiment

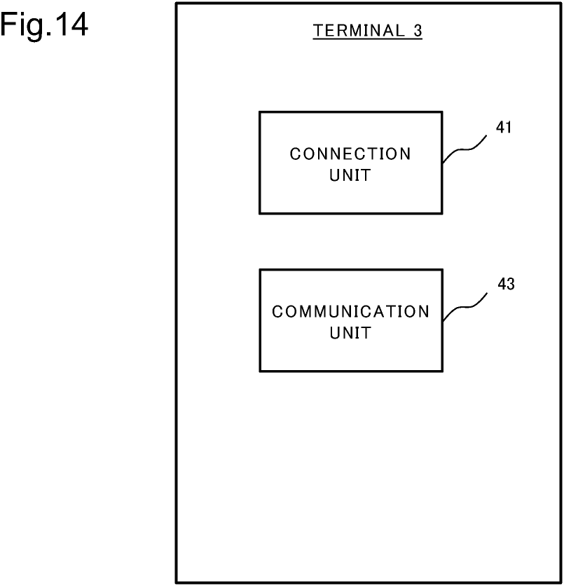

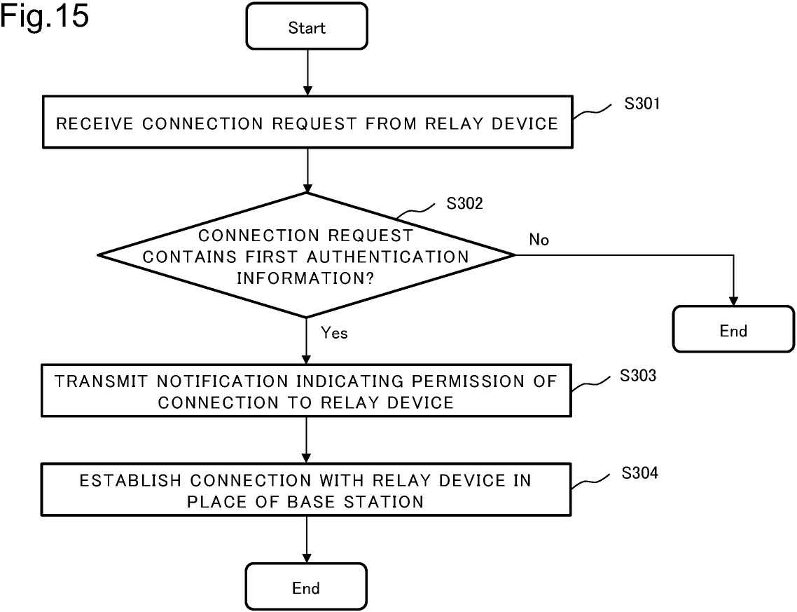

With reference to FIGS. 14 and 15, a terminal 3 according to a third example embodiment is described. FIG. 14 is a block diagram illustrating a configuration example of the terminal 3. FIG. 15 is a flowchart illustrating an operation example of the terminal 3.

As illustrated in FIG. 14, the terminal 3 includes a connection unit 41 and a communication unit 43.

The connection unit 41 is connected to a base station. The connection unit 41 may include a configuration, a function, and a connection-related object similar to that of the connection unit 41 in the terminal 40 described in the first example embodiment.

The communication unit 43 determines whether a connection request received from a relay device contains authentication information. When the connection request contains the authentication information, the communication unit 43 transmits a notification indicating connection permission to the relay device. At this point, the connection unit 41 is connected to the relay device in place of the base station after the communication unit 43 transmits the notification to the relay device. Here, connection to the relay device indicates that transmission and reception of other data are performed with the relay device as well as transmission and reception of the notification with the relay device. The communication unit 43 may include a configuration, a function, and a connection-related object similar to that of the communication unit 43 in the terminal 40 described in the first example embodiment.

Next, with reference to FIG. 15, an operation example of the terminal 3 is described. It is assumed that, at the time of starting this operation example, the connection unit 41 is connected to the base station.

The communication unit 43 receives the connection request from the relay device (S301). Further, the communication unit 43 determines whether the connection request contains the authentication information (S302).

When the connection request does not contain the authentication information (No in S302), the terminal 3 terminates the operation. When the connection request contains the authentication information (Yes in S302), the communication unit 43 transmits the notification indicating connection permission to the relay device (S303). After the processing in S303, the connection unit 41 is connected to the relay device in place of the base station. The operation of the terminal 3 is described above.

As described above, the terminal 3 includes the connection unit 41 and the communication unit 43. The connection unit 41 is connected to the base station. The communication unit 43 determines whether the connection request received from the relay device contains the authentication information, and transmits, to the device, the notification indicating connection permission when the connection request contains the authentication information. Further, after the communication unit 43 transmits the notification to the relay device, the connection unit 41 is connected to the relay device in place of the base station.

Thereby, even when a failure occurs in the base station due to a disaster or the like, the terminal 3 is capable of communicating with the network via the relay device. Thus, the terminal 3 can be prevented from communicating with a device that does not have authentication information. As a result, the terminal 3 has a low risk of being connected to an inappropriate system that extracts information from the terminal 3, and performs introduction to a malicious web site, distribution of false information, or the like.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-145194, filed on Aug. 31, 2020, the disclosure of which is incorporated herein in its entirety by reference.

Reference Signs List

| 1, 1A | Relay system |
|---|---|
| 2 | Relay device |
| 3 | Terminal |
| 10 | Notification device |
| 20 | Network |
| 21 | Server |
| 30, 30A, 30B | Base station |
| 40, 40A, 40B, 40C, 40D | Terminal |
| 41 | Connection unit |
| 42 | Update unit |
| 43 | Communication unit |
| 50, 50A, 2 | Relay device |
| 51 | Transmission unit |
| 52 | Reception unit |
| 53 | Relay unit |
| 54 | Encryption unit |
| 55 | Transmission unit |

What is claimed is:

1. A relay device comprising:
a transmitter configured to transmit a connection request containing authentication information to a terminal when a failure occurs in a base station, the terminal being connected to a network via the base station;
a receiver configured to receive a notification indicating permission of connection from the terminal receiving the connection request; and
a relayer configured to relay communication between the terminal and the network when the receiver notifies that the notification is received.

2. The relay device according to claim 1, further comprising:
an encryptor configured to encrypt information from the network; and
a transmitter configured to transmit the encrypted information to the terminal.

3. A terminal comprising:
a connector configured to establish a connection with a base station; and
a communicator configured to determine whether a connection request received from a relay device contains authentication information, and transmit, to the relay device, a notification indicating permission of connection when the connection request contains the authentication information, wherein
the connector establishes a connection with the relay device in place of the base station, after the communicatortransmits the notification to the relay device.

4. The terminal according to claim 3, further comprising
an updater configured to subsequently update the authentication information, wherein
the communicator transmits the updated authentication information to the relay device.

5. The terminal according to claim 3, wherein
the communicator decrypts encrypted information received from the relay device, based on a common key unique to the terminal.

6. A relay system comprising:
the relay device according to claim 1; and
the terminal according to any one of claims 3.

7. The relay system according to claim 6, further comprising
a plurality of the terminals, wherein
the authentication information differs for each of the terminals.

8. A relay method comprising:
transmitting a connection request containing authentication information to a terminal when a failure occurs in a base station, the terminal being connected to a network via the base station;
receiving a notification indicating permission of connection from the terminal receiving the connection request; and
relaying communication between the terminal and the network when the notification is received.
